(19) United States
(12) Patent Application Publication
(10) Pub. No.: US 2015/0318631 A1
(43) Pub. Date: Nov. 5, 2015

(54) FLEXIBLE CABLE CONNECTOR

(71) Applicant: Molex Incorporated, Lisle, IL (US)

(72) Inventors: Suk Min KIM, Ansan (KR); Kwan Yeong HWANG, Ansan (KR)

(73) Assignee: Molex Incorporated, Lisle, IL (US)

(21) Appl. No.: 14/702,829

(22) Filed: May 4, 2015

(30) Foreign Application Priority Data
May 2, 2014 (KR) 10-2014-0053647

(51) Int. Cl. H01R 12/79; H01R 12/70; H01R 12/71

(52) U.S. Cl. CPC H01R 12/79; H01R 12/718; H01R 12/7005

(57) ABSTRACT

Disclosed herein is a connector for contacting a flexible cable with a printed circuit board (hereinafter “PCB”) that enables the connector to contact the flexible cable directly to the PCB without using a terminal as a medium. The connector includes a housing that is fixed to a PCB and forms an insertion space between it and the PCB, whereinto a flexible cable is inserted; and an actuator mounted rotatably on the housing that pushes downward on the top of the flexible cable inserted into the insertion space so as to put the conductor part of the flexible cable in direct contact with the conductor part of the top of the PCB.

### RELATED APPLICATIONS

This application claims priority to Korean Application No. 10-2014-0053647, filed May 2, 2014, which is incorporated herein by reference in its entirety.

### TECHNICAL FIELD

This invention relates to a connector for contacting a flexible cable with a printed circuit board (hereinafter “PCB”); more specifically, it relates to a flexible cable connector that puts the flexible cable in direct contact with the PCB without the medium of a terminal.

### BACKGROUND ART

With the recent trend toward smaller and higher-performance electronic products, many electronic components are placed on PCBs, and consequently many signals are input and output in parallel. For the electrical contact with devices, flexible flat cables (FFC) and flexible printed circuits (FPC) are widely used, in which a plurality of electrical wires are brought together as a single cable.

The flexible cable connectors of the prior art comprised a housing, fixed to the PCB and molded from plastic; a terminal formed as a plurality of termini inserted into the housing from the back of the housing and fixed in place; and an actuator that fixes the flexible cable inserted into the front of the housing in place in the housing. Examples of prior art include Republic of Korea Registered Patent Gazette No. 10-1170428 (issued 2012 Aug. 7) and Republic of Korea Registered Patent Gazette No. 10-1310138 (issued 2013 Sep. 23).

The flexible cable connectors of the prior art, having this configuration, are designed so as to establish a connection between the flexible cable and the PCB mediated by the termini: the flexible cable is first inserted into the housing with the actuator in its open state, and then the flexible cable is put in contact with the termini when the actuator is closed. The housing is fixed to the PCB by means of a fitting nail.

In the case of a flexible cable connector of the prior art having the above-described configuration, the signal transmission architecture and overall connector architecture are complex, because the flexible cable is contacted to the PCB by the medium of the termini, and the housing is fixed to the PCB by a separate fitting nail. As a result, it is difficult to reduce product manufacturing costs and miniaturize products.

### SUMMARY OF THE INVENTION

In one embodiment, the flexible cable connector of this invention comprises: a housing that is fixed to a PCB and forms an insertion space between it and the PCB, into which a flexible cable is inserted; and an actuator mounted rotatably on the housing that pushes downward on the top of the flexible cable inserted into the insertion space so as to put the conductor part of the flexible cable in direct contact with the conductor part of the top of the PCB. The material of the housing can be metal, and the actuator is closed by rotating toward the front of the housing and opened by rotating away from the front of the housing. Axle(s) can be formed on the part of the actuator that makes up the back end thereof when the actuator is closed, and part of the axle(s) push downward on the flexible cable when the actuator is closed, so as to push the cable into close contact with the PCB. On the part of the housing that covers the top of the insertion space, axle through-hole(s) can be formed from top to bottom so that the axle(s) can pass through; and on the top of the through-hole(s) of the housing and support beam(s) are furnished that provides elastic support by pressing downward on the axle(s). A plurality of axles and support beams can be respectively formed spaced apart from one another; each support beam provides elastic support individually to each axle. The insertion space can be open toward the front and back of the housing, and the flexible cable can be inserted via the open part of the insertion space. On the part of said housing located on the side opposite the direction in which the flexible cable is inserted a stopper part can be formed to restrict the insertion of the flexible cable.

The housing can include a lower surface part installed at an interval from the PCB and forming said insertion space in the space between it and the PCB, and having the axle through-hole(s) formed therein; an axle support part bent upward from the back end of the lower surface part so as to overlap with the lower surface part, the support beam(s) being formed on the end thereof; a soldering part wherein the back end of the lower surface part or part of the axle support part is separated and soldered to the PCB; a stopper part, formed by separating the back end of the lower surface part or part of the axle support part(s); and a fitting part that covers the side of the insertion space and is soldered to the PCB, formed as a single unit with both sides of the lower surface part respectively.

The housing can also include a lower surface part installed at an interval from the PCB and forming an insertion space in the space between it and the PCB, and having the axle through-hole(s) formed therein; an axle support part bent upward from the back end of the lower surface part so as to overlap with the lower surface part, the support beam being formed on the end thereof; a soldering part wherein the front end of the lower surface part is separated and soldered to the PCB; a stopper part, formed by separating the front end of the lower surface part; and a fitting part that covers the side of the insertion space and is soldered to the PCB, formed in a single unit with both sides of the lower surface part respectively.

As can be appreciated, the end(s) of the support beam(s) can be positioned facing the front of the housing, and on the front part of the axle through-hole(s), axle detachment prevention part(s) can be formed bent upward from the lower surface part so as to overlap it, thus preventing forward detachment of the axle(s).

The axle(s) of the actuator is formed with a shape that is long in the vertical direction and short in the front-back direction when the actuator is closed. On the housing, a rotation prevention structure can be furnished that prevents the actuator from rotating further than necessary toward the back of the housing when the actuator is opened. An outward-sloping guide part can be formed on the front end or back end of said fitting part, on the side where the flexible cable is inserted, so that the flexible cable can easily be inserted into the insertion space. On the front end of the lower surface part, an upward-sloping guide part can be formed so that the flexible cable can easily be inserted into the insertion space.

The following effects can be obtained from the flexible cable connector disclosed herein.

First, because it is configured so that the flexible cable is contacted directly with the PCB, without terminals, and no separate fitting nail is required, the signal transmission architecture and overall connector architecture can be simplified, and as a result, the product manufacturing costs can be reduced and the products miniaturized.

Second, because it is configured so that the support beam furnished on this housing presses independently on the axle of the actuator to provide support, and thereby a consistent contact pressure can be maintained for each pin of the PCB and the flexible cable, it can maintain a stable contact between the flexible cable and the PCB. In particular, because identical reliability of contact can be ensured at either end and in the center, even as the number of pins in the PCB and flexible cable increase, the contact status thereof can be kept consistent (i.e. it can be applied over a wide range of cases, from few pins to many pins).

### BRIEF DESCRIPTION OF THE DRAWINGS

FIG. 1 is an oblique view of the flexible cable connector of this invention according to Embodiment 1, for insertion of an FPC.

FIG. 2 is an oblique view of an FPC having been fully inserted into the flexible cable connector of this invention according to Embodiment 1.

FIG. 3 is an exploded oblique view of the flexible cable connector of this invention according to Embodiment 1.

FIGS. 4 through 6 are cross-sections showing the process of the FPC being inserted.

FIG. 7 is a cross-section showing the coupling relationship between the actuator and the fitting nail shown in FIG. 3.

FIG. 8 is an oblique view of the insertion of an FPC into the flexible cable connector of this invention according to Embodiment 2.

FIG. 9 is an oblique view of an FPC having been inserted into the flexible cable connector of this invention according to Embodiment 2.

FIGS. 10 through 12 are cross-sections showing the process of the FPC being inserted in accordance with Embodiment 2 of this invention.

### DETAILED DESCRIPTION OF THE PREFERRED EMBODIMENTS

Described below are preferred embodiments of the flexible cable connector of this disclosure and they will be described in detail with reference to the attached drawings. The purpose of this invention, which has been devised in order to address the above-described problems of the prior art, is to provide a flexible cable connector that can simplify the signal transmission architecture and overall connector architecture. Although only an FPC will be described in these embodiments, by way of example of a flexible cable, the flexible cable used is not limited thereto, and other flexible cables such as FFCs can also be used.

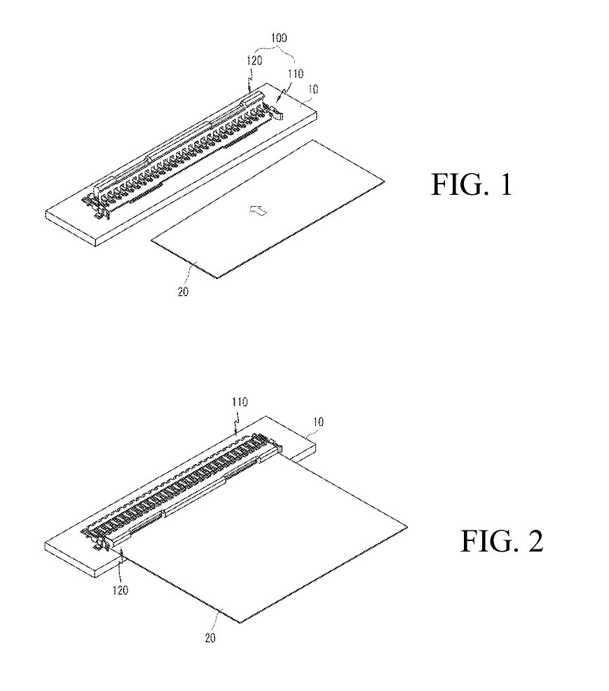

FIG. 1 is an oblique view of the flexible cable connector of this invention according to Embodiment 1, for insertion of an FPC; FIG. 2 is an oblique view of an FPC having been fully inserted into the flexible cable connector of this invention according to Embodiment 1.

The flexible cable connector (100) according to this embodiment comprises: a housing (110) that is soldered to a PCB (10) and forms an insertion space between it and the PCB (10) into which an FPC (20) is inserted; and an actuator (120) that is mounted rotatably on the housing (110) so as to press down on the top surface of the FPC (20) inserted into the insertion space so as to establish a direct contact between the FPC (20) and the PCB (10). Here the housing (110) is a metal shell of a metallic material.

The flexible cable connector (100) according to this embodiment has a front-flip type structure; the actuator (120) is closed by rotating toward the front of the housing (110), and the FPC (20) is inserted via the front of the housing (110). The actuator (120) is opened by rotating in the direction away from the front side of the housing (110).

As shown in FIG. 1, when the actuator (120) has been opened, the FPC (20) is inserted into or removed from the insertion space via the front of the housing (110). The actuator (120) is vertical when opened.

As shown in FIG. 2, after the FPC (20) has been fully inserted into the insertion space, if the actuator (120) is closed by rotating it toward the front of the housing (110), the FPC (20) is then firmly fixed in place within the insertion space, and the FPC (20) is brought into close contact with the top surface of the PCB (10) as each of its contact pins are brought into direct contact.

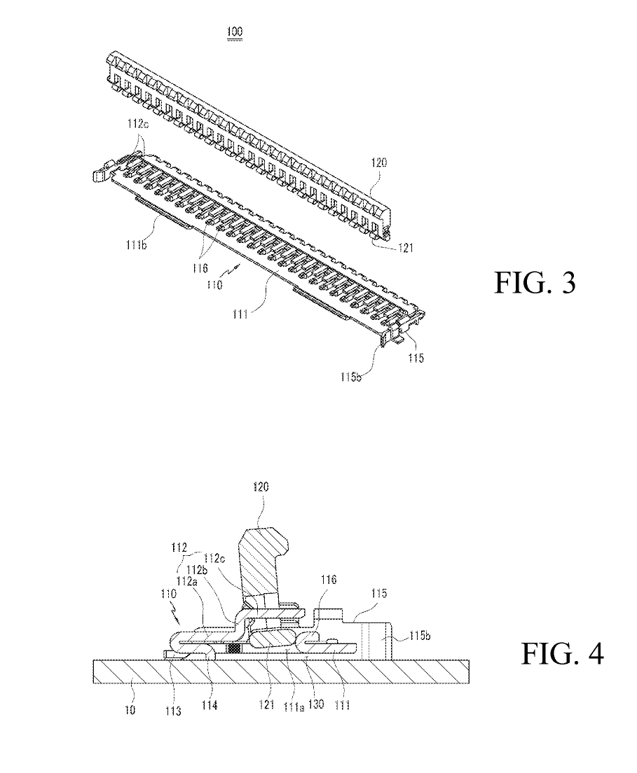

FIG. 3 is an exploded oblique view of the flexible cable connector of this invention according to Embodiment 1; FIGS. 4 through 6 are cross-sections showing the process of the FPC being inserted.

The flexible cable connector (100) of this invention comprises a housing (110) formed of metal, and an actuator (120) formed of an insulator such as plastic. The housing (110) comprises a lower surface part (111), axle support part (112), soldering part (113), FPC stopper part (114), fitting part (115), and axle detachment prevention part (116). Axles (121) are furnished in the actuator (120).

A lower surface part (111) is installed at an interval above the PCB (10), and forms an insertion space (130) between it and the PCB (10), into which the FPC (20) is inserted. On the lower surface part (111), a plurality of axle through-holes (111a) are formed, spaced apart to left and right in the same number as the axles (121), so that the axles (121) of the actuator (120) can be inserted thereinto and rotated therewithin. The insertion space (130) of the housing (110) is open to the front.

The axle support parts (112) extend from the rear of the lower surface part (111), and are bent so as to overlap the lower surface part (111) so as to elastically support the axles (121) of the actuator (120). The ends of the axle support parts (112) are positioned facing toward the front of the housing (110). The axle support parts (112) comprise an extension part (112a) that extends from the back end of the lower surface part (111) and are bent so as to overlap the lower surface part (111); a vertical part that is bent vertically upward from the end of the extension part (112a); and a support beam (112c) that is bent horizontally forward from the top end of the vertical part (112b) so as to push against and support the axle (121). A plurality of support beams (112c) are formed spaced apart to left and right, positioned above each axle through-hole (111a). Due to the bending structure of this axle support part (112), the support beam (112c) possesses elasticity, and each support beam (112c) individually provides elastic support to the axle (121).

The soldering part (113) is formed separately from the back end of the lower surface part (111) and is soldered to the PCB (10).

The FPC stopper part (114) is formed separately extending downward from the lower surface part (111) so as to cover the rear side of the insertion space (130) and restrict the insertion of the FPC (20).

A plurality of soldering parts (113) and FPC stopper parts (114) are formed and positioned alternating with one another. The soldering parts (113) and FPC stopper parts (114) are formed separately from the lower surface part (111), but are not limited thereto, and may also be formed separately from the axle support part (112).

The fitting part (115) is formed extending to either side of the lower surface part (111) as a single unit, so as to be soldered to the PCB (10) and cover the sides of the insertion space (130).

The axle detachment prevention part (116) extends from the lower surface part (111) in front of the through-holes (111a), and is bent so as to overlap the top of the lower surface part (111) so that it prevents forward detachment of the axles (121). Because the axle detachment prevention part (116) is formed protruding above the top surface of the lower surface part (111), when the axle (121) of the actuator (120) is rotated within the axle through-hole (111a), the axle (121) catches on it and therefore cannot detach toward the front. Because the bent part of the axle detachment prevention part (116) forms a curve, when the axle (121) is rotated, it can rotate smoothly without damage.

On the front end of the lower surface part (111) that makes up the housing (110), a guide part (111b) is formed, sloping upward in an oblique direction, that guides the FPC (20) so that it can be easily inserted; likewise, on the front end of the fitting part (115), a guide part (115b) is formed, sloping outward, that guides the FPC (20) so that it can be easily inserted.

On the part of the actuator (120) that makes up the back end thereof when it is closed, a plurality of axles (121) are formed spaced apart from one another; when the actuator (120) is closed, some of the axles (121) push the FPC (20) downward to establish close contact with the PCB (10). The axles (121), as shown in FIG. 6, are formed in a shape that, when the actuator (120) is closed, is long in the vertical direction and short in the front-back direction. As a result, as shown in FIG. 6, when the axles (121) are closed, the long part is vertical and pushes on the FPC (20); and as shown in FIG. 4, when they are open, the long part becomes horizontal and the force that had been pushing on the FPC (20) is released, and it becomes possible to insert or remove the FPC (20).

When the actuator is opened (120) and enters the vertical position, the part formed between the axles (121) on the back end of the actuator (120) is inserted between the support beams (112c) so as to catch on the part where the support beams (112c) are formed, so as to prevent rotation further back than the open state of the actuator (120).

The process of inserting an FPC (20) into a flexible cable connector (100) of this invention, having the above-described configuration, will now be described with reference to FIGS. 4 through 6.

As shown in FIG. 4, when the actuator (120) is in vertical position, the long parts of the axles (121) are in a horizontal position within the axle through-holes (111a), and the insertion space (130) is entirely open.

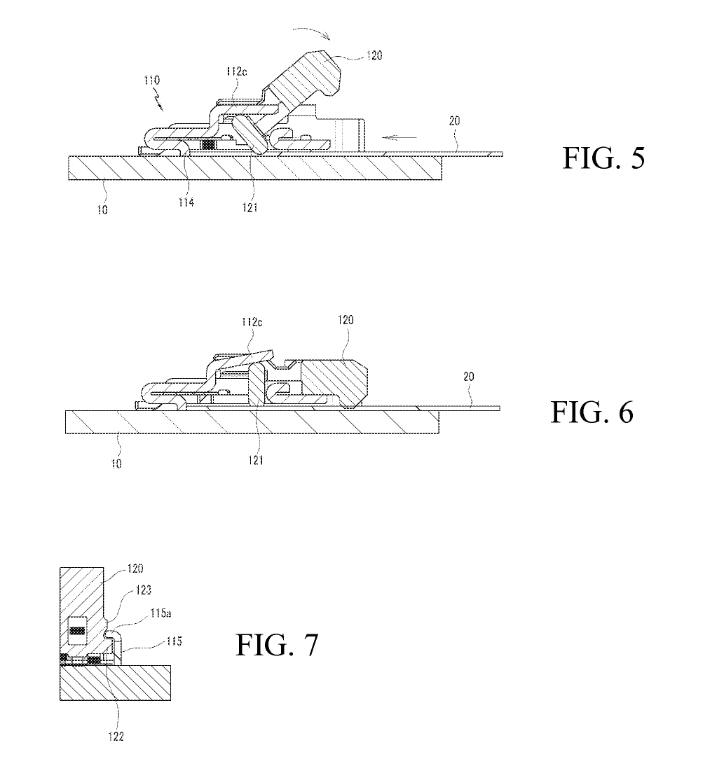

As shown in FIG. 5, the FPC (20) is inserted into the insertion space (130) via the front of the housing (110), and the front end of the FPC (20) is inserted until it cannot be inserted any further due to contacting the FPC stopper part (114). When the FPC (20) has been fully inserted, the actuator (120) is rotated toward the front of the housing (110). In this process, the axles (121) of the actuator (120) rotate while being supported by the support beams (112c) of the axle support parts (112) so that they cannot detach upward. The support beams (112c) possess elasticity and therefore are not damaged and are lifted upward.

As shown in FIG. 6, when the actuator (120) is completely closed, the long parts of the axles (121) become vertical, and one end of the long part pushes on the top surface of the FPC (20), while the other end is contacted and pushed by the support beam (112c). The axles (121) are pushed downward by the elastic force of the support beams (112c), so that the FPC (20) is in close contact with the top surface of the PCB (10), which causes the contact pins of the FPC (20) to come into direct contact with the contact pins of the PCB (10).

FIG. 7 is a cross-section showing the coupling relationship between the actuator and the fitting nail shown in FIG. 3.

On the top of the fitting part (115), a tab (115a) is formed, bent toward the actuator (120), that prevents the sides of the actuator (120) from being lifted upward. A blocking part (122) protrudes below the tab (115a) on either side of the actuator (120). Rotation prevention blocks (123) are formed spaced apart from the blocking parts (122) on either side of the actuator (120), so that when the actuator (120) has been placed in vertical position, they will catch on the tab (115a) and prevent undesired rotation of the actuator (120).

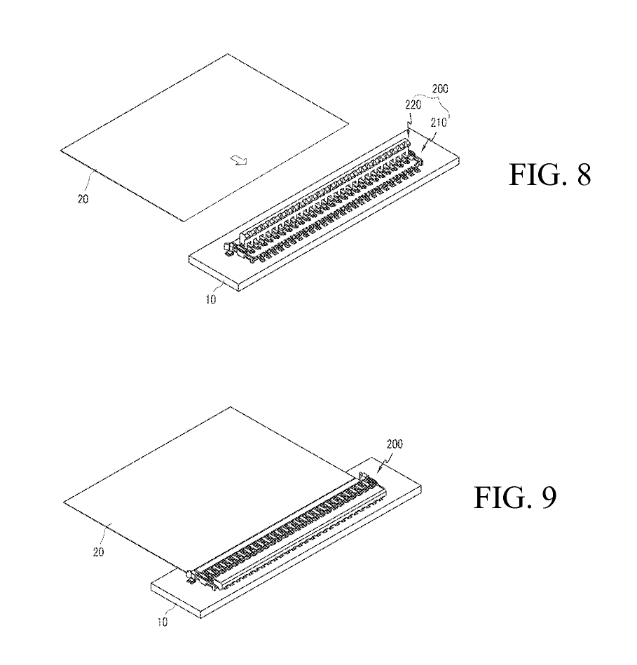

FIG. 8 is an oblique view of the insertion of an FPC into the flexible cable connector of this invention according to Embodiment 2; FIG. 9 is an oblique view of an FPC having been inserted into the flexible cable connector of this invention according to Embodiment 2.

The flexible cable connector (200) according to this embodiment comprises: a housing (210) that is soldered to a PCB (10) and forms an insertion space between it and the PCB (10) into which an FPC (20) is inserted; and an actuator (220) that is mounted rotatably on the housing (210) so as to press down on the top surface of the FPC (20) inserted into the insertion space so as to establish a direct contact between the FPC (20) and the PCB (10).

The flexible cable connector (200) according to this embodiment has a back-flip type structure; the actuator (220) is closed by rotating toward the front of the housing (210), and the FPC (20) is inserted via the back of the housing (210).

As shown in FIG. 8, when the actuator (220) has been opened, the FPC (20) is inserted into or removed from the insertion space via the back of the housing (210). The actuator (220) is vertical when opened.

As shown in FIG. 9, after the FPC (20) has been fully inserted into the insertion space, if the actuator (220) is closed by rotating it toward the front of the housing (210), the FPC (20) is then firmly fixed in place within the insertion space, and the FPC (20) is brought into close contact with the top surface of the PCB (10) as each of its contact pins are brought into direct contact.

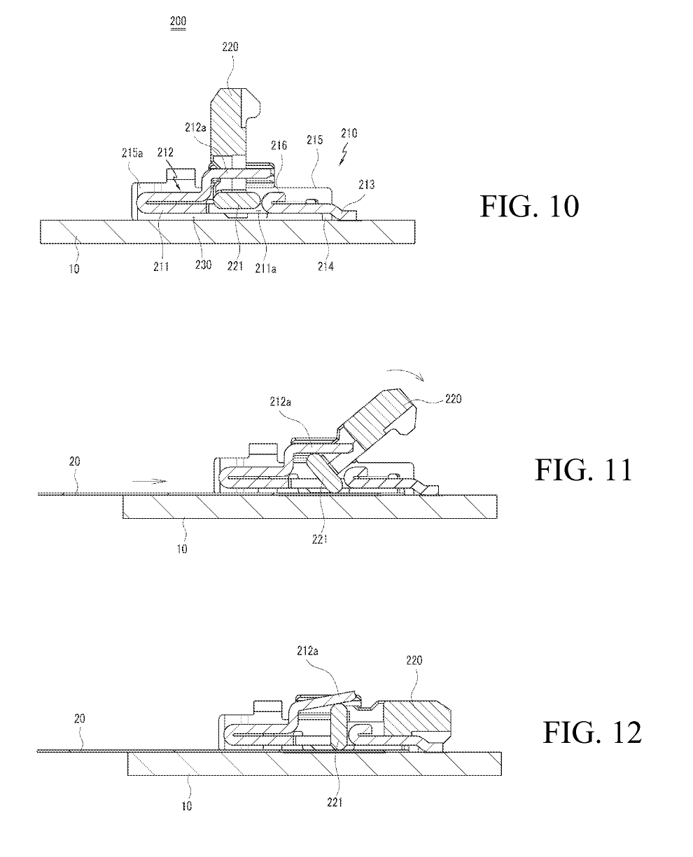

FIGS. 10 through 12 are cross-sections showing the process of the FPC being inserted in accordance with Embodiment 2 of this invention.

The flexible cable connector (200) of this invention comprises a housing (210) formed of metal, and an actuator (220) formed of an insulator such as plastic. The housing (210) comprises a lower surface part (211), axle support part (212), soldering part (213), FPC stopper part (214), fitting part (215), and axle detachment prevention part (216). Axles (221) are furnished in the actuator (220).

The flexible cable connector (200) according to this embodiment is formed so that the insertion space (230) formed between the lower surface part (211) of the housing (210) and the PCB (10) is open toward the back of the housing (210). To this end, the soldering part (213) soldered to the PCB (10) is formed separately from the front end of the lower surface part (211), and the FPC stopper part (214) that restricts the insertion of the FPC (20) is also formed separately from the front of the lower surface part (211).

The guide part (111b) formed on the front end of the lower surface part (111) in Embodiment 1 is not formed in this embodiment. Specifically, no separate guide part is configured because the axle support part (212) is bent and extended from the back end of the lower surface part (211), and the bent portion forms a curve, so that when the FPC (20) is inserted into the back of the housing (210), the FPC (20) can be inserted easily and without damage.

In Embodiment 1, a guide part (115b) was formed on the front end of the fitting part (115), but in this embodiment, the guide part (215a) is formed on the back end of the fitting part (215).

The process of inserting an FPC (20) into a flexible cable connector (200) of this invention, having the above-described configuration, will now be described with reference to FIGS. 10 through 12.

As shown in FIG. 10, when the actuator (220) is in vertical position, the long parts of the axles (221) are in a horizontal position within the axle through-holes (211a), and the insertion space (230) is entirely open.

As shown in FIG. 11, the FPC (20) is inserted into the insertion space (230) via the rear of the housing (210), and the front end of the FPC (20) is inserted until it cannot be inserted any further due to contacting the FPC stopper part (214). When the FPC (20) has been fully inserted, the actuator (220) is rotated toward the front of the housing (210). In this process, the axles (221) of the actuator (220) rotate while being supported by the support beams (212c) of the axle support parts (212) so that they cannot detach upward.

As shown in FIG. 12, if the actuator (220) is completely closed, the long parts of the axles (221) become vertical, and one end of the long part pushes on the top surface of the FPC (20), while the other end is pushed by the support beam (212a). The axle (221) is pushed downward by the elastic force of the support beam (212c), so that the FPC (20) is pushed into close contact with the top surface of the PCB (10), which causes the contact pins of the FPC (20) to directly contact the contact pins of the PCB (10).

Hereinabove, a description has been given of the flexible cable connector of this invention, based on preferred embodiments; however, this invention is not limited to specific embodiments, and a person having ordinary skill in the art of the relevant field can modify these embodiments in various ways without departing from the scope disclosed in the claims.

What is claimed is:

1. Flexible cable connector, comprising:
a housing that is fixed to a PCB and that forms an insertion space between it and the PCB,
whereinto a flexible cable is inserted; and
an actuator mounted rotatably on said housing that pushes downward on the top of the flexible cable inserted into said insertion space so as to put the conductor part of the flexible cable in direct contact with the conductor part of the top of the PCB.

2. Flexible cable connector according to claim 1, wherein the material of said housing is metal, and wherein said actuator is closed by rotating it toward the front of the housing and opened by rotating it away from the front of the housing.

3. Flexible cable connector according to claim 2, wherein axle(s) are formed on the part of said actuator that makes up the back end thereof when the actuator is closed, and part of the axle(s) push downward on the flexible cable when the actuator is closed, so as to put it in close contact with the PCB.

4. Flexible cable connector according to claim 3, wherein on the part of said housing that covers the top of said insertion space, axle through-hole(s) are formed from top to bottom so that the axle(s) can pass through, and on the top of the through-hole(s) of the housing, support beam(s) are furnished that provide elastic support by pressing downward on said axle(s).

5. Flexible cable connector according to claim 4, wherein a plurality of said axle(s) and support beam(s) are formed spaced apart from one another, and each said support beam individually provides elastic support to the respective axle.

6. Flexible cable connector according to claim 5, wherein said insertion space is open to the front or back of said housing, and said flexible cable is inserted into the open part of said insertion space.

7. Flexible cable connector according to claim 6, wherein on the part of said housing located on the side opposite the direction in which said flexible cable is inserted, a stopper part is formed to restrict the insertion of said flexible cable.

8. Flexible cable connector according to claim 7, wherein said flexible cable is inserted via the front of the housing,
and said housing comprises:
a lower surface part installed at an interval from said PCB and forming said insertion space in the space between it and the PCB, and having said axle through-hole formed therein;
an axle support part bent upward from the back end of said lower surface part so as to overlap with the lower surface part, said support beam being formed on the end thereof;
a soldering part wherein the back end of said lower surface part or part of the axle support part is separated and soldered to said PCB;
said stopper part, formed by separating the back end of said lower surface part or part of the axle support part; and
a fitting part that covers the side of the insertion space and is soldered to the PCB, formed as a single unit with both sides of said lower surface part respectively.

9. Flexible cable connector according to claim 8, wherein an outward-sloping guide part is formed on the front end or back end of said fitting part, on the side where the flexible cable is inserted, so that the flexible cable can easily be inserted into said insertion space.

10. Flexible cable connector according to claim 8, wherein on the front end of said bottom surface part, an upward-tilted guide part is formed so that the flexible cable can easily be inserted into the insertion space.

11. Flexible cable connector according to claim 8, wherein the end of said support beam is positioned facing the front of the housing, and on the front part of said axle through-hole, an axle detachment prevention part is formed that prevents forward detachment of the axle, by bending upward from the lower surface part so as to overlap.

12. Flexible cable connector according to claim 11, wherein the axle of said actuator is formed with a shape that is long in the vertical direction and short in the front-back direction when the actuator is closed.

13. Flexible cable connector according to claim 12, wherein on said housing is furnished a rotation prevention structure that prevents any more rotation than necessary of the actuator toward the rear of the housing when the actuator is opened.

14. Flexible cable connector according to claim 7, wherein said flexible cable is inserted via the rear of the housing,
and said housing comprises:
a lower surface part installed at an interval from said PCB and forming said insertion space in the space between it and the PCB, and having said axle through-hole formed therein;
an axle support part bent upward from the front end of said lower surface part so as to overlap with the lower surface part, said support beam being formed on the end thereof;
a soldering part wherein the front end of said lower surface part is separated and soldered to said PCB;
said stopper part, formed by separating the front end of said lower surface part; and
a fitting part that covers the side of the insertion space and is soldered to the PCB, formed as a single unit with both sides of said lower surface part respectively.
